(19) United States
(12) Patent Application Publication
(10) Pub. No.: US 2012/0141917 A1
(43) Pub. Date: Jun. 7, 2012

(54) PROTON CONDUCTING SOLID OXIDE ELECTROLYTE MEMBRANE, MEA AND FUEL CELL INCLUDING THE MEMBRANE, AND METHOD OF PREPARING THE MEMBRANE

(75) Inventors: Sang-kyun Kang, Seoul (KR); Turgut M. Gür, (US); Friedrich B. Prinz, (US); Joon-hyung Shim, Seoul (KR)

(73) Assignees: The Board of Trustees of the Leland Stanford Jr. University, Palo Alto, CA (US); Samsung Electronics Co., Ltd., Suwon-si (KR)

(21) Appl. No.: 13/167,828

(22) Filed: Jun. 24, 2011

Related U.S. Application Data
(60) Provisional application No. 61/420,424, filed on Dec. 7, 2010.

(51) Int. Cl. H01M 8/12; C23F 1/00

(52) U.S. Cl. 429/496; 216/13

(57) ABSTRACT

A proton-conducting solid oxide electrolyte membrane includes a nanoporous layer including a plurality of nanopores that penetrate from one surface to the other, and at least one proton conducting layer that fills the plurality of nanopores to have an interface in a direction perpendicular to either surface of the nanoporous layer.

### CROSS-REFERENCE TO RELATED APPLICATION

This application claims the benefit of U.S. Provisional Application No. 61/420,424, filed Dec. 7, 2010 in the U.S. Patent & Trademark Office, the disclosure of which is incorporated herein by reference.

### STATEMENT OF GOVERNMENT SUPPORT

This invention was made with Government support under contract N00014-07-10758 awarded by the Office of Naval Research. The Government has certain rights in this invention.

### BACKGROUND

1. Field

Aspects of the present disclosure relate to proton-conducting solid electrolyte membranes, membrane-electrode assemblies (MEA) and fuel cells each including one of the proton-conducting solid electrolyte membranes, and methods of preparing the proton-conducting solid electrolyte membranes.

2. Description of the Related Art

According to the types of electrolyte used, fuel cells, drawing attention as alternative energy sources, may be classified as either polymer electrolyte membrane fuel cells (PEMFC), phosphoric acid fuel cells (PAFC), molten carbonate fuel cells (MCFC), or solid oxide fuel cells (SOFC).

Proton-conducting solid oxide fuel cells, a kind of SOFC, use proton-conducting solid oxide electrolytes. Proton-conducting solid oxide fuel cells have high efficiency and high durability, adapt to various kinds of fuels, and are also cost-effective.

Proton-conducting solid oxide fuel cells include a solid oxide electrolyte and electrodes in each unit cell. Since proton-conducting solid oxide fuel cells operate at high temperatures of 600° C. or higher, materials available are therefore restricted only to those stable at such high temperatures. In this regard, there has been a demand to lower the operating temperature of proton-conducting solid oxide fuel cells. However, at a low operating temperature a proton-conducting solid oxide electrolyte membrane may undergo a significant reduction in conductivity, which leads to significantly increased resistance and reduced output density.

Therefore, there is a demand for technologies that increase the conductivities of such proton-conducting solid oxide electrolyte membranes.

### SUMMARY

An aspect of the present invention provides a novel proton-conducting solid oxide electrolyte membrane.

An aspect of the present invention provides a membrane-electrode assembly (MEA) including the proton-conducting solid oxide electrolyte membrane.

An aspect of the present invention provides a solid oxide fuel cell (SOFC) including the MEA.

An aspect of the present invention provides a method of preparing the proton-conducting solid oxide electrolyte membrane.

According to an aspect of the present invention, a proton-conducting solid oxide electrolyte membrane includes: a nanoporous layer including a plurality of nanopores that penetrate from one surface to the other; and at least one proton conducting layer that fills the plurality of nanopores to have an interface in a direction perpendicular to either surface of the nanoporous layer.

According to another aspect of the present invention, a membrane-electrode assembly includes: an anode; a cathode: and the proton-conducting solid oxide electrolyte membrane described above between the anode and the cathode.

According to another aspect of the present invention, a proton-conducting solid oxide fuel cell includes the membrane-electrode assembly described above.

According to another aspect of the present invention, a method of manufacturing a proton-conducting solid oxide electrolyte membrane includes: preparing a nanoporous layer including a plurality of nanopores that penetrate from one surface to the other; filling the plurality of nanopores with at least one proton conducting layer by depositing a proton conductor at least one time on the nanoporous layer to form an interface of the at least one proton conducting layer with the nanoporous layer in a direction perpendicular to either surface of the nanoporous layer; and partially etching the at least one proton conducting layer deposited on the nanoporous layer to expose the interface of the at least one proton-conducting layer.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIGS. 1A to 1F are schematic views illustrating a method of preparing a proton-conducting solid oxide electrolyte membrane, according to an exemplary embodiment of the present invention;

FIG. 2 is a scanning electron microscopic (SEM) image of a nanoporous layer formed of anodic aluminum oxide (AAO);

FIG. 3 is a schematic illustration of proton conductor samples used to measure conductivities of a proton-conducting solid oxide electrolyte membrane; and

FIG. 4 is a schematic illustration of a proton conductor model, which satisfies Equation 1.

### DETAILED DESCRIPTION

Reference will now be made in detail to the present embodiments of the present invention, examples of which are illustrated in the accompanying drawings, wherein like reference numerals refer to like elements throughout. The embodiments are described below in order to explain the present invention by referring to the figures.

Hereinafter, one or more embodiments of a proton-conducting solid oxide electrolyte membrane, a membrane-electrode assembly (MEA) and a fuel cell, each including the proton-conducting solid oxide electrolyte membrane, and a method of preparing the proton-conducting solid oxide electrolyte membrane according to aspects of the present invention the invention will be described in more detail.

According to an exemplary embodiment of the invention, a proton-conducting solid oxide electrolyte membrane includes: a nanoporous layer including a plurality of nanopores that penetrate from one surface to the other of the nanoporous layer; and at least one proton conducting layer that fills the plurality of nanopores to have an interface in a direction perpendicular to either surface of the nanoporous layer.

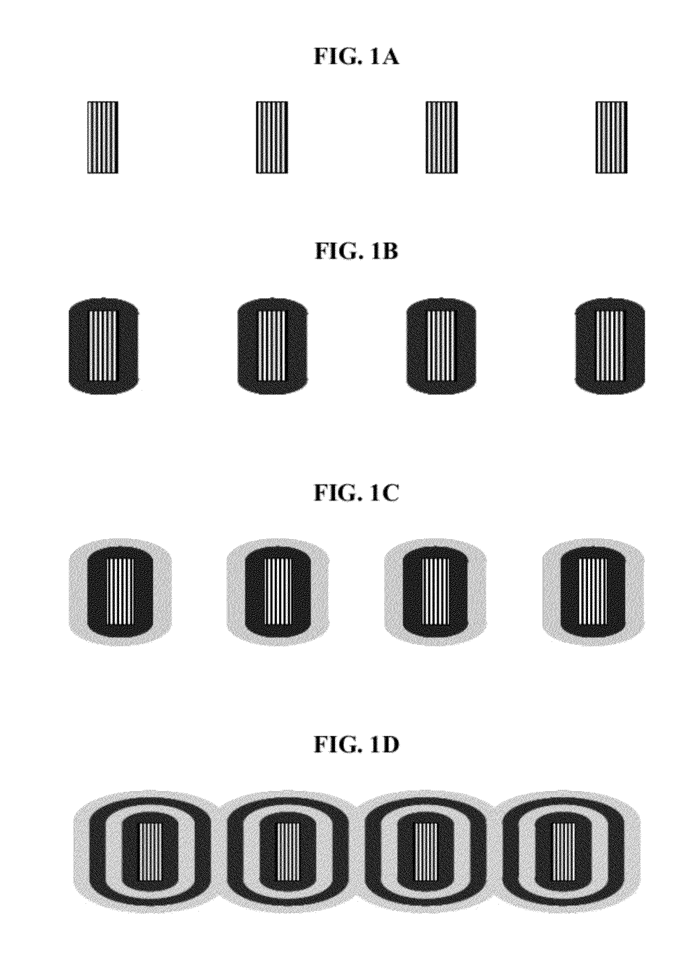

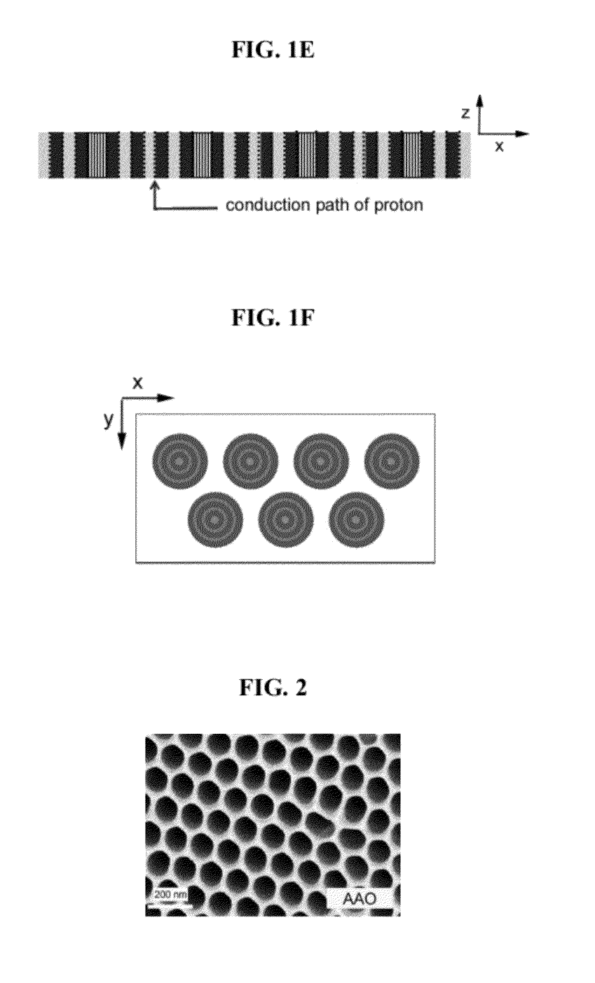

As used herein, the term “perpendicular direction” refers to any direction in which protons penetrate through the electrolyte membrane and conduct from one surface to the other, not only the direction at 90° with respect to either surface of the electrolyte membrane. For example, the term “perpendicular direction” may refer to a direction that protrudes from either surface of the electrolyte membrane. For example, the “perpendicular direction” may refer to z direction of FIG. 1E.

The at least one proton conducting layer may form at least one interface with the nanoporous layer, a proton insulating layer, or another proton conducting layer if there are at least two proton conducting layers.

As the proton-conducting layer forms at least one interface, the proton-conducting solid oxide electrolyte membrane may have improved conductivity. In some embodiments the interface conductivity of the proton-conducting layer may be greater than the bulk conductivity thereof.

Research revealed that a proton conductor sample (a) having a higher surface area-to-volume ratio had higher proton conductivity than a proton conductor sample (b) having a lower surface area to volume ratio, and the difference in proton conductivity between the two samples increased with decreasing temperatures (J. Phys. Chem. B 2001, 105, 11399-111401). This is attributed to a higher surface conductivity of the proton conductor than the bulk conductivity. Atoms on the proton conductor surface cannot bind each other in a direction projecting above the surface, since there are no additional atoms to bind. Thus, the atoms on the surface of the proton conductor are unstable, and thus may actively vibrate or rotate, thereby facilitating diffusion of protons throughout the proton conductor surface and resulting in a high surface conductivity of the proton conductor.

Thus, in a structure also having another layer on the surface of the proton conductor, wherein the additional layer may have a different crystalline structure from the proton conductor, atoms disposed on the surface of the proton conductor layer may be mismatched at the interface between the proton conductor and the additional layer and remain in an unstable binding state.

For example, in a proton-conducting solid oxide electrolyte membrane in which a nanoporous layer made of amorphous aluminum oxide is filled with a crystalline proton conducting layer, the different crystalline structures of the proton conducting layer and the amorphous aluminum oxide layer may cause atoms to be mismatched in the interface between the two layers, so that the proton conductivity layer may have a higher surface conductivity than bulk conductivity. As the thickness of the proton conducting layer decreases to a nanometer scale, the surface conductivity may be more influential.

For example, a rectangular proton conductor of FIG. 4 may have a total conductivity, a surface conductivity, and a bulk conductivity that satisfy Equation 1 below.

σₜₒₜₐₗ·tₜₒₜₐₗ=σₛ·tₛ+σ_{b}·t_{b} Equation 1

In Equation 1, σₜₒₜₐₗ represents total conductivity of the proton conductor, tₜₒₜₒₐₗ represents total thickness of the proton conductor, σₛ represents the surface conductivity, tₛ represents the thickness of a surface part, σ_{b} represents the bulk conductivity, and t_{b} represents the thickness of a bulk part.

If the total conductivity, the total thickness and the bulk conductivity of the proton conductor are measured, and the surface part has a certain thickness, the bulk thickness and the surface conductivity can be calculated therefrom. In Equation 1 above, the total conductivity, the total thickness, and the bulk conductivity are constants, the thickness of the bulk part is practically constant, and the thickness of the surface part is in inverse proportion to the surface conductivity. Equation 1 shows that the smaller the thickness of the surface part, the greater the surface conductivity of the proton conductor.

The proton-conducting layer forms interfaces with the nanopores connecting the opposite surfaces of the nanoporous layer. As the thickness of the proton conducting layer decreases more and more to a nanometer scale, the interface conductivity may be abruptly increased. Consequently, the proton-conducting solid oxide electrolyte membrane including the nanoporous layer may have a significantly reduced area specific resistance.

The proton-conducting layer may completely fill the nanopores of the nanoporous layer to completely block crossover of fuel and migration of electrons.

The at least one proton-conducting layer of the proton-conducting solid oxide fuel cell may have a superlattice structure. Superlattice structures refer to periodic structures in which at least two different material layers are alternately arranged.

In some embodiments the at least one proton-conducting layer may have a concentric superlattice structure. That is, a plurality of proton-conducting layers may concentrically sequentially fill each nanopore of the nanoporous layer. The smaller the thickness of the proton-conducting layer, the larger the number of proton-conducting layers that may fill each nanopore, and thus, the more interfaces may be formed between the proton-conducting layers and the nanoporous layer.

In some embodiments the proton-conducting solid oxide electrolyte membrane may include an alternating at least one proton-conducting layer and different proton-conducting layer. The proton-conducting solid oxide electrolyte membrane may include alternating at least two proton-conducting layers having different surface structures. The at least two different proton-conducting layers having different surface structures may be any proton-conducting layers, as long as they have a higher interface conductivity than a bulk conductivity thereof.

In some embodiments the at least one proton-conducting layer of the proton-conducting solid oxide electrolyte membrane may include alternating layers of proton-conducting layers and proton insulating layers. That is, the at least one proton-conducting layer may partially include an insulating layer. The proton insulating layer may be an amorphous insulating layer. The proton insulating layer may be highly likely to be mismatched with the proton-conducting layer.

In some embodiments these alternating layers may be concentric in the proton-conducting solid oxide electrolyte membrane. That is, the proton conducting solid oxide electrolyte membrane may have a structure in which a plurality of alternating layers concentrically fill each nanopore of the nanoporous layer.

In the proton-conducting solid oxide electrolyte membrane, the proton-conducting layer may have a thickness of about 1 nm to about 300 nm, and in some embodiments, may have a thickness of about 1 nm to about 200 nm, and in some embodiments, may have a thickness of about 1 nm to about 100 nm, and in some embodiments, may have a thickness of about 1 nm to about 50 nm, and in some embodiments, may have a thickness of about 1 nm to about 20 nm. The smaller the thickness of the proton-conducting layer, the greater the surface conductivity of the proton-conducting layer may be.

In the proton-conducting solid oxide electrolyte membrane, the nanopores may have a diameter of about 20 nm to about 500 nm, and in some embodiments, may have a diameter of about 20 nm to about 400 nm, and in some embodiments, may have a diameter of about 20 nm to about 300 nm, and in some embodiments, may have a diameter of about 20 nm to about 200 nm, and in some embodiments, may have a diameter of about 20 nm to about 100 nm.

In the proton-conducting solid oxide electrolyte membrane, the nanopores may have any cross-sectional shape that may be formed in the art, for example, selected from among circular, oval, triangular, rectangular, square, polygonal, and irregular shapes.

In the proton-conducting solid oxide electrolyte membrane, the nanopores may have a spacing of about 50 nm to about 500 nm, and in some embodiments, may have a spacing of about 50 nm to about 400 nm, and in some embodiments, may have a spacing of about 50 nm to about 300 nm, and in some embodiments, may have a spacing of about 50 nm to about 200 nm, and in some embodiments, may have a spacing of about 50 nm to about 100 nm. The spacing between the nanopores refers to the interval between the centers of every two adjacent nanopores.

In the proton-conducting solid oxide electrolyte membrane, the nanoporous layer may have a thickness of about 5 μm to about 5 mm, and in some embodiments, may have a thickness of about 10 μm to about 1 nm, and in some embodiments, may have a thickness of about 10 μm to about 800 μm, and in some embodiments, may have a thickness of about 10 μm to about 500 μm, and in some embodiments, may have a thickness of about 10 μm to about 300 μm, and in some embodiments, may have a thickness of about 10 μm to about 100 μm.

The proton-conducting layer of the proton-conducting solid oxide electrolyte membrane may include at least one material selected from among proton-substituted zeolite; β-alumina; and perovskite compounds, such as barium zirconate, barium cerate, strontium cerate, and strontium zirconate, each perovskite compound being doped with divalent or trivalent cations. Any suitable proton-conducting material that may be used to form proton-conducting solid oxide electrolytes in the art may be used.

In some embodiments the proton-conducting layer may include a compound represented by Formula 1 below.

AD₁₋ₓBₓO_{3-d} Formula 1

wherein 0.05≦x≦0.3; 0≦d<3; A is selected from among barium (Ba), strontium (Sr), lanthanum (La), and calcium (Ca); B is selected from among zirconium (Zr), cerium (Ce), titanium (Ti), tin (Sn), terbium (Tb), and erbium (Er); and D is selected from among yttrium (Y), gadolinium (Gd), indium (In), scandium (Sc), samarium (Sm), and ytterbium (Yb).

The nanoporous layer of the proton-conducting solid oxide electrolyte membrane may be an electric insulator. In some embodiments the nanoporous layer may include a material selected from among Al₂O₃, MgO, SiO₂, and Si. However, any suitable electrically insulating, nanoporous material commonly used in the art may be used. In some embodiments the nanoporous layer may include an anodic aluminum oxide (AAO).

In some embodiments the nanoporous layer of the proton-conducting solid oxide electrolyte membrane may be a proton conductor. In this regard, proton conduction may occur along the interfaces between the proton-conducting layer and the nanoporous layer in the proton-conducting solid oxide electrolyte membrane, and also through the bulk electrolyte.

In some embodiments the nanoporous layer of the proton-conducting solid oxide electrolyte membrane may be a proton insulator.

In some embodiments the at least one proton-conducting layer of the proton-conducting solid oxide electrolyte membrane may be formed using a method selected from among atomic layer deposition (ALD), chemical vapor deposition (CVD), physical vapor deposition (PVD), sputtering, plating, pulsed laser deposition (PLD), and molecular beam epitaxy (MBE). However, any method that is suitable for forming an conformal layer on a porous layer in the art may be used. The conformal layer means a morphologically uneven interface or surface layer with another body and has a thickness that is the same everywhere along the interface or surface. Either electroplating or electroless plating may be used to form the at least one proton-conducting layer.

The proton-conducting solid oxide electrolyte membrane may have a thickness of about 60 μl, a ratio of the nanopores to the proton-conducting solid oxide electrolyte membrane of about 50% by volume, a ratio of the proton conductor in the nanopores of about 50% by volume, and an area specific resistance of 0.2 Ω·cm² or less at an operating temperature of 200° C., and in some embodiments, an area specific resistance of 0.01 Ω·cm² or less. The smaller the thickness of the proton conducting layer of the proton-conducting solid oxide electrolyte membrane, the smaller the area specific resistance may become.

According to another exemplary embodiment of the invention, a membrane-electrode assembly (MEA) includes an anode; a cathode; and the proton-conducting solid oxide electrolyte membrane between the anode and the cathode.

The anode and cathode may each have a thin film or porous structure that may transmit oxide ions or protons. The anode and the cathode may each independently include at least one material selected from the group consisting of: metals, such as platinum (Pt), nickel (Ni), palladium (Pd), and silver (Ag); perovskites doped with at least one metal selected from the group consisting of lanthanum (La), strontium (Sr), barium (Ba), and cobalt (Co); oxide ion conductors, such as zirconia doped with yttrium (Y) or scandium (Sc), and ceria doped with at least one rare earth selected from among gadolinium (Gd), samarium (Sm), lanthanum (La), ytterbium (Yb), and neodymium (Nd); a proton conducting metal, such as Pd, Pd—Ag alloys, and vanadium (V); zeolite; lanthanum strontium manganate (LSM) doped with lanthanum (La) or calcium (Ca); and lanthanum strontium cobalt ferrite (LSCF). However, any suitable anode and cathode materials commonly used in the art may be used.

The anode and the cathode may each independently have a thickness less than 10 μm. In some embodiments each of the anode and the cathode may have a thickness of about 5 nm to less than 5 μm, and in some embodiments, may have a thickness of about 5 nm to about 2.5 μm, and in some embodiments, may have a thickness of about 5 nm to about 500 nm, and in some embodiments, may have a thickness of about 5 nm to about 200 nm.

The MEA may further include a catalyst on one surface of each of the anode and the cathode. The catalyst may be in the form of particles on a sub-micron scale. In some embodiments the catalyst may be in the form of nanoparticles.

Examples of the catalyst include at least one material selected from the group consisting of: a metal catalyst, such as platinum (Pt), ruthenium (Ru), nickel (Ni), palladium (Pd), nickel (Ni), gold (Au), and silver (Ag) and alloys thereof; oxide catalysts, such as La₁₋ₓSrₓMnO₃ (0<x<1), La₁₋ₓSrₓCoO₃(0<x<1), and La₁₋ₓSrₓCO_{y}Fe_{1-y}O₃(0<x<1, 0<y<1). However, any suitable catalyst commonly used in the art may also be used.

According to another exemplary embodiment of the invention, a proton-conducting solid oxide fuel cell includes the MEA. Due to the use of the MEA the proton-conducting solid oxide fuel cell may have an improved output density at low temperatures, for example, less than 400° C.

According to another exemplary embodiment of the invention, a method of preparing the proton-conducting solid oxide electrolyte membrane includes: preparing a nanoporous layer including a plurality of nanopores penetrating one surface to the other; filling the plurality of nanopores with at least one proton conducting layer by depositing a proton conductor at least one time on the nanoporous layer to have an interface of the at least one proton conducting layer with the nanoporous layer in a direction perpendicular to either surface of the nanoporous membrane; and partially etching the at least one proton conducting layer deposited on the nanoporous layer to expose the interface of the proton conducting layer.

In some embodiments of the method, the nanoporous layer may be formed of a material selected from among Al₂O₃, MgO, SiO₂, and Si. However, any suitable electrically insulating, nanoporous material commonly used in the art may be used. In some embodiments the nanoporous layer may be formed of an anodic aluminum oxide (AAO).

In some embodiments the nanoporous layer may be formed of a proton conductor. In this regard, proton conduction may occur along the interfaces between the proton-conducting layer and the nanoporous layer in the proton-conducting solid oxide electrolyte membrane, and also through the bulk electrolyte.

In some embodiments the nanoporous layer may be formed of a proton insulator.

In some embodiments the deposition of the proton conductor may be performed using a method selected from among atomic layer deposition (ALD), chemical vapor deposition (CVD), physical vapor deposition (PVD), sputtering, plating, pulsed laser deposition (PLD), and molecular beam epitaxy (MBE). However, any suitable method commonly used in the art may be used.

In some embodiments the at least one proton-conducting layer may be formed of at least one material selected among proton-substituted zeolite; β-alumina; and perovskite compounds, such as barium zirconate, barium cerate, strontium cerate, and strontium zirconate, each perovskite compound being doped with divalent or trivalent cations. Any suitable proton-conducting material that may be used to form proton-conducting solid oxide electrolytes in the art may be used.

In some embodiments the proton-conducting layer may be formed of a compound represented by Formula 1 below:

AD₁₋ₓBₓO_{3-d} Formula 1

wherein 0.05≦x≦0.3; 0≦d<3; A is selected from among barium (Ba), strontium (Sr), lanthanum (La), and calcium (Ca); B is selected from among zirconium (Zr), cerium (Ce), titanium (Ti), tin (Sn), terbium (Tb), and erbium (Er); and D is selected from among yttrium (Y), gadolinium (Gd), indium (In), scandium (Sc), samarium (Sm), and ytterbium (Yb).

In some embodiments in the deposition of the proton conductor on the nanoporous layer, the proton conductor and a proton insulator may be alternately deposited. In some other embodiments, different kinds of proton conductors may be alternately deposited on the nanoporous layer.

Thus, the at least one proton-conducting layer may have a superlattice structure. For example, the at least one proton-conducting layer may include alternating layers of different proton conducting layers, and in some embodiments, may include alternating layers of proton conducting layers and proton insulating layers.

In some embodiments the filling of the plurality of nanopores with at least one proton conducting layer by depositing a proton conductor at least one time on the nanoporous layer to form an interface of the at least one proton conducting layer with the nanoporous layer in a direction perpendicular to either surface of the nanoporous membrane may include partially filling the plurality of nanopores with some of the at least one proton conducting layer and then completely filling the plurality of nanopores with the remaining proton conducting layer. In other words, the nanopores may be completely filled by performing deposition one or several times.

The partial etching of the at least one proton conducting layer may be performed using any etching method that is commonly used in the art.

Exemplary embodiments of the method of preparing the proton-conducting solid oxide electrolyte membrane will now be described in more detail with reference to FIGS. 1A to 1F. Initially, a nanoporous layer having a plurality of nanopores that penetrate from one surface to the other of the nanoporous layer is prepared (see FIG. 1A). FIG. 1A is an enlarged cross-sectional view of a nanoporous layer of FIG. 2, which is formed of AAO. In FIG. 1A, four rectangles correspond to oxide layers, and spaces therebetween correspond to nanopores. Then, a first conformal proton conducting layer is deposited on the nanoporous layer by using, for example, ALD, to partially fill the nanopores (FIG. 1B). Then, a first conformal proton insulating layer is formed on the first conformal proton conducting layer (FIG. 1C). Subsequently, a second conformal proton conducting layer is formed on the first conformal proton insulating layer, and then, a second conformal proton insulating layer is formed on the second proton conducting layer to completely fill the nanopores (see FIG. 1D). The number of conformal proton conducting layers, such as the first and second conformal proton conducting layers, may vary depending on the desired structure and manufacturing conditions. Then, top and bottom surfaces of the nanoporous layer, which include the nanopores filled with the first and second conformal proton conducting layers and the first and second proton insulating layers, are etched to expose interfaces between the first and second conformal proton conducting and insulating layers (see FIG. 1E), thereby manufacturing the proton-conducting solid oxide electrolyte membrane. The interfaces of the first and second proton conducting layers with the oxide layers or the first and second proton insulating layers are denoted by dotted lines in FIG. 1E. FIG. 1F is a top view of the proton-conducting solid oxide electrolyte membrane, in which the nanopores of the nanoporous layer are concentrically filled with a plurality of proton conducting layers, more specifically, the alternating proton conducting layer and proton insulating layers. In some embodiments, the first and second proton conducting layers may be formed of Y:BaCeO₃, and the first and second proton insulating layers may be formed of alumina.

The conductivity of a surface part of a proton conducting solid oxide electrolyte membrane according to an embodiment of the present invention may vary depending on the thickness of the surface part, which may be calculated based on the data disclosed in J. Phys. Chem. B 2001, 105, 11399-111401 and Equation 1 below.

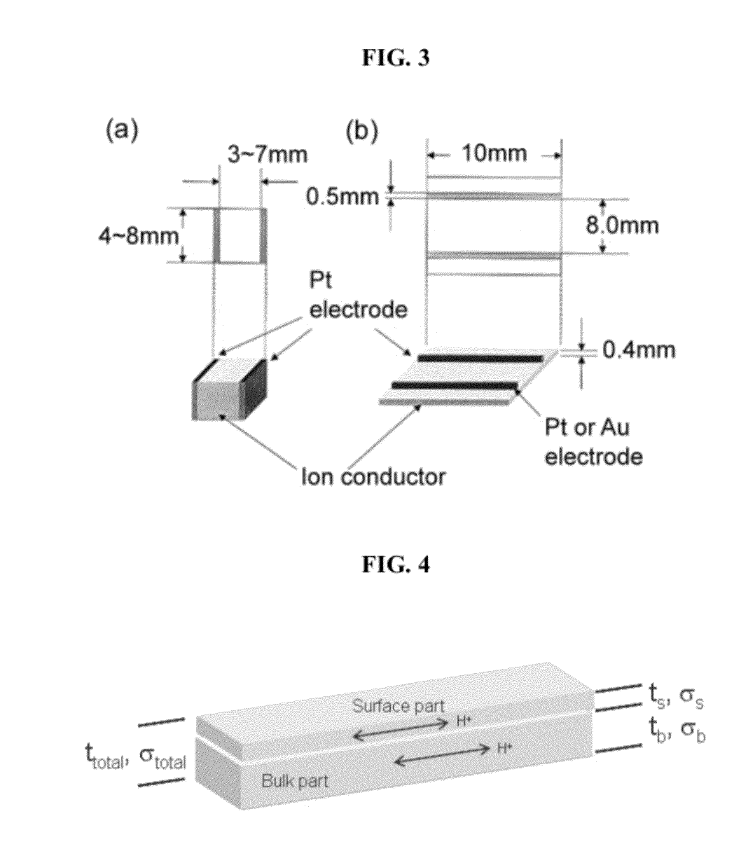

J. Phys. Chem. B 2001, 105, 11399-111401 disclosed a proton conductor sample (a) and a proton conductor sample (b), as illustrated in FIG. 3, wherein the proton conductor sample (a) having a relatively larger thickness than the proton conductor sample (b) had a conductivity of 0.0027 s/cm at 400° C., and the proton conductor sample (b) having a thickness of 400 μm had a conductivity of 0.0082 s/cm at 400° C.

A rectangular proton conductor as illustrated in FIG. 4 may have a total conductivity, a surface conductivity, and a bulk conductivity that satisfy Equation 1 below.

σₜₒₜₐₗ·tₜₒₜₐₗ=σₛ·tₛ+σ_{b}·t_{b} Equation 1

In Equation 1, σₜₒₜₐₗ represents total conductivity of the proton conductor, tₜₒₜₐₗ represents total thickness of the proton conductor, σₛ represents the surface conductivity, tₛ represents the thickness of a surface part, σ_{b} represents the bulk conductivity, and t_{b} represents the thickness of a bulk part.

Under the assumption that the proton conductor has a total thickness of 400 μm, a total conductivity of 0.0082 s/cm, and a bulk conductivity of 0.0027 s/cm, the conductivities of the surface part at different thicknesses were calculated. The results are shown in Table 1.

TABLE 1

| tₜₒₜₐₗ | σₜₒₜₐₗ | σ_{b} | tₛ | t_{b} | σₛ | Enhancement |
|---|---|---|---|---|---|---|
| [um] | [s/cm] | [s/cm] | [um] | [um] | [s/cm] | [σₛ/σ_{b}] |
| 400 | 0.0082 | 0.0027 | 1 | 399 | 2.20008 | 801 |
| | | | 0.5 | 399.5 | 4.397413 | 1,601 |
| | | | 0.2 | 399.8 | 10.98941 | 4,001 |
| | | | 0.1 | 399.9 | 21.97608 | 8,001 |
| | | | 0.05 | 399.95 | 43.94941 | 16,001 |
| | | | 0.02 | 399.98 | 109.8694 | 40,001 |
| | | | 0.01 | 399.99 | 219.7361 | 80,001 |
| | | | 0.005 | 399.995 | 439.4694 | 160,001 |
| | | | 0.001 | 399.999 | 2197.336 | 800,001 |

Referring to Table 1, the surface conductivities are significantly increased with decreasing thicknesses of the surface part. As an example, when the surface part has a thickness of 10 nm, the surface conductivity is about 80,000 times greater than the bulk conductivity.

The area specific resistance (ASR) of a proton-conducting solid oxide electrolyte membrane, which has a particular shape at 200° C. may be calculated based on the calculated results of Table 1 and Equation 2 below.

Equation 2 below may be used to calculate an area specific resistance of a proton-conducting solid oxide electrolyte membrane including pores.

$$A S R = \frac{membrane thickness}{\begin{matrix}{σ}_{b} ( T ) \cdot Enhancement ( t ) \cdot \\ ( surface conductor proportion within membrane )\end{matrix}} \qquad Equation 2$$

In Equation 2 above, σ_{b}(T) represents bulk conductivity at a certain temperature, Enhancement (t) represents the ratio of surface conductivity to bulk conductivity [σₛ/σ_{b}] at the certain temperature, “membrane thickness” represents the thickness of the proton-conducting solid oxide electrolyte membrane, and “surface conductor proportion within membrane” represents the product obtained by multiplying the proportion of pores in the membrane by the proportion of proton conductor layer in the pores.

For example, in a proton-conducting solid oxide electrolyte membrane having a structure as illustrated in FIG. 1, when the ratio of nanopores to the proton-conducting solid oxide electrolyte membrane is 0.5, the ratio of the proton conductor layer to the nanopores is 0.5, the proton conductor, which is Y:BaCeO₃, has a conductivity of 6.9×10⁻⁵ s/cm at 200° C., the proton-conducting layer has a thickness of 10 nm, and the electrolyte membrane has a thickness of 60 μm, the proton-conducting solid oxide electrolyte membrane may have an area specific resistance of 4.35×10⁻³ Ω·cm², which is calculated using Equation 2 above.

Therefore, if a proton-conducting solid oxide electrolyte membrane includes a proton-conducting layer having a thickness in nanometers in a nanoporous layer, wherein the proton-conducting layer fills nanopores of the nanoporous layer to form interfaces with the nanoporous layer in a direction perpendicular to either surface of the nanoporous layer, the proton-conducting solid oxide electrolyte membrane may have a very low area specific resistance at a low temperature of 200° C., even with a thickness of several micrometers, which is thick enough to be handled easily.

As described above, according to the one or more above embodiments of the present invention, a proton-conducting solid oxide electrolyte membrane is manufactured to include interfaces of proton-conducting layers penetrating from one surface to the other surface thereof, and thus may have a reduced area specific resistance.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton-conducting solid oxide electrolyte membrane comprising:
a nanoporous layer including a plurality of nanopores that penetrate from one surface to the other; and
at least one proton conducting layer that fills the plurality of nanopores to have an interface in a direction perpendicular to either surface of the nanoporous layer.

2. The proton-conducting solid oxide electrolyte membrane of claim 1, wherein the at least one proton conducting layer has a superlattice structure.

3. The proton-conducting solid oxide electrolyte membrane of claim 1, wherein the at least one proton conducting layer has a concentric superlattice structure.

4. The proton-conducting solid oxide electrolyte membrane of claim 1, wherein the at least one proton-conducting layer comprises alternating layers of different proton-conducting layers.

5. The proton-conducting solid oxide electrolyte membrane of claim 1, wherein the at least one proton-conducting layer comprises alternating layers of proton conducting layers and proton insulating layers.

6. The proton-conducting solid oxide electrolyte membrane of claim 4, wherein the alternating layers are concentric.

7. The proton-conducting solid oxide electrolyte membrane of claim 1, wherein the at least one proton-conducting layer has a thickness of about 1 nm to about 300 nm.

8. The proton-conducting solid oxide electrolyte membrane of claim 1, wherein the nanopores have a diameter of about 20 nm to about 500 nm.

9. The proton-conducting solid oxide electrolyte membrane of claim 1, wherein the nanopores have a spacing of about 50 nm to about 500 nm.

10. The proton-conducting solid oxide electrolyte membrane of claim 1, wherein the nanoporous layer has a thickness of about 5 μl to about 5 mm.

11. The proton-conducting solid oxide electrolyte membrane of claim 1, wherein the at least one proton-conducting layer comprises at least one material selected from the group consisting of proton-substituted zeolite; β-alumina; and perovskite compounds including barium zirconate, barium cerate, strontium cerate, and strontium zirconate, each perovskite compound being doped with divalent or trivalent cations.

12. The proton-conducting solid oxide electrolyte membrane of claim 1, wherein the at least one proton-conducting layer is a compound represented by Formula 1 below:
AD₁₋ₓBₓO_{3-d} Formula 1
wherein 0.05≦x≦0.3,
0≦d≦3,
A is selected from the group consisting of barium (Ba), strontium (Sr), lanthanum (La), and calcium (Ca),
B is selected from the group consisting of zirconium (Zr), cerium (Ce), titanium (Ti), tin (Sn), terbium (Tb), and erbium (Er), and
D is selected from the group consisting of yttrium (Y), gadolinium (Gd), indium (In), scandium (Sc), samarium (Sm), and ytterbium (Yb).

13. The proton-conducting solid oxide electrolyte membrane of claim 1, wherein the nanoporous layer is at least one material selected from the group consisting of Al₂O₃, MgO, SiO₂, and Si.

14. The proton-conducting solid oxide electrolyte membrane of claim 1, wherein the proton-conducting solid oxide electrolyte membrane has a thickness of about 60 μl, and an area specific resistance of 0.2 Ω·cm² or less at an operating temperature of 200° C., the nanopores are about 50% by volume of the electrolyte membrane, and the at least one proton-conducting layer is about 50% by volume of the nanopores.

15. The proton-conducting solid oxide electrolyte membrane of claim 14, wherein the proton-conducting solid oxide electrolyte membrane has an area specific resistance of 0.01 Ω·cm² or less.

16. A membrane-electrode assembly comprising:
an anode;
a cathode: and
the proton-conducting solid oxide electrolyte membrane of claim 1 disposed between the anode and the cathode.

17. A proton-conducting solid oxide fuel cell comprising the membrane-electrode assembly of claim 16.

18. A method of manufacturing a proton-conducting solid oxide electrolyte membrane, the method comprising:
preparing a nanoporous layer including a plurality of nanopores that penetrate from one surface to the other;
filling the plurality of nanopores with at least one proton conducting layer by depositing a proton conductor at least one time on the nanoporous layer to form an interface of the at least one proton conducting layer with the nanoporous layer in a direction perpendicular to either surface of the nanoporous layer; and
partially etching the at least one proton conducting layer deposited on the nanoporous layer to expose the interface of the at least one proton-conducting layer.

19. The method of claim 18, wherein the deposition of the proton conductor is performed using a method selected from the group consisting of atomic layer deposition (ALD), chemical vapor deposition (CVD), physical vapor deposition (PVD), sputtering, plating, pulsed laser deposition (PLD), and molecular beam epitaxy (MBE).

20. The method of claim 18, wherein the deposition of the proton conductor comprises alternately depositing the proton conductor and a proton insulator on the nanoporous layer.

21. The method of claim 18, wherein the deposition of the proton conductor comprises alternately depositing different proton conductors.

22. The proton-conducting solid oxide electrolyte membrane of claim 5, wherein the alternating layers are concentric.
